(19) United States
(12) Patent Application Publication
(10) Pub. No.: US 2016/0093844 A1
(43) Pub. Date: Mar. 31, 2016

(54) BATTERY STACK

(71) Applicants: TOYOTA JIDOSHA KABUSHIKI KAISHA, Toyota-shi (JP); SANYO Electric Co., Ltd., Daito-shi (JP)

(72) Inventors: Masato KAMIYA, Anjo-shi (JP); Taira SAITO, Miyoshi-shi (JP); Daisuke IKEDA, Kakogawa-shi (JP); Keisuke MINAMI, Kakogawa-shi (JP); Toyoki FUJIHARA, Kanzaki-gun (JP)

(73) Assignees: SANYO ELECTRIC CO., LTD., Daito-shi (JP); TOYOTA JIDOSHA KABUSHIKI KAISHA, Toyota-shi (JP)

(21) Appl. No.: 14/869,214

(22) Filed: Sep. 29, 2015

(30) Foreign Application Priority Data
Sep. 30, 2014 (JP) 2014-200861

(51) Int. Cl. H01M 2/10; H01M 2/34

(52) U.S. Cl. CPC H01M 2/1016; H01M 2/345

(57) ABSTRACT

A first end plate is disposed at one end, in a stacking direction, of a stacked body of secondary battery cells. A second end plate is disposed at the other end, in the stacking direction, of the stacked body of the secondary battery cells. A restraining member is joined to the first end plate and the second end plate. The restraining member applies, to the first end plate and the second end plate, restraint loads that sandwich and restrain the stacked body from both sides in the stacking direction. The first end plate is movable relative to the second end plate in the state where the restraining member is joined to both the first end plate and the second end plate.

### INCORPORATION BY REFERENCE

The disclosure of Japanese Patent Application No. 2014-200861 filed on Sep. 30, 2014 including the specification, drawings and abstract is incorporated herein by reference in its entirety.

### BACKGROUND OF THE INVENTION

1. Field of the Invention

The invention relates to a battery stack and, in particular, relates to a battery stack formed by stacking a plurality of battery cells each having a current interrupt device.

2. Description of Related Art

Conventionally, there is proposed a battery pack in which unit batteries are arranged side by side and integrated by fastening end plates disposed at both ends in an arrangement direction of the unit batteries by means of restraining bands (see, e.g. Japanese Patent Application Publication No. 2001-68081 (JP 2001-68081 A)).

Further, there is proposed a battery module including a pair of end plates disposed at both ends of a battery unit in which a plurality of batteries are connected to each other, restrainers joined to the end plates, and joining units configured to fix one of the end plates to the restrainers while allowing joint positions therebetween to be changed (see, e.g. Japanese Patent Application Publication No. 2011-129509 (JP 2011-129509 A)).

Further, there is proposed a battery module in which a battery is sandwiched between a first restraining plate and a second restraining plate having deformable portions and, when the pressure inside the battery reaches a predetermined value, the deformable portions are deformed to relieve the pressure (see, e.g. Japanese Patent Application Publication No. 2013-114943 (JP 2013-114943 A)).

As a technique for interrupting a current of a lithium-ion battery at the time of overcharging, the generation of gas due to an overcharge additive contained in an electrolyte solution and a current interrupt device (CID) have been widely used in combination thereof.

### SUMMARY OF THE INVENTION

A battery stack according to an aspect of the invention includes a plurality of battery cells. Each battery cell includes a battery element; a housing receiving the battery element therein; an external terminal disposed outside the housing; and a current interrupt device. The current interrupt device is configured to operate when an internal pressure of the housing is increased, thereby interrupting electrical connection between the battery element and the external terminal. The plurality of battery cells are stacked in one direction to form a stacked body. The battery stack further includes a first end plate, a second end plate, and a restraining member. The first end plate is disposed at one end, in the one direction, of the stacked body of the battery cells. The second end plate is disposed at the other end, in the one direction, of the stacked body of the battery cells. The restraining member is joined to the first end plate and the second end plate. The restraining member is configured to apply, to the first end plate and the second end plate, restraint loads that sandwich and restrain the stacked body from both sides in the one direction. The first end plate is movable relative to the second end plate in a state where the restraining member is joined to both the first end plate and the second end plate.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing a secondary battery cell that forms a battery stack according to an embodiment of the invention;

FIG. 2 is a diagram for explaining a current interrupt device provided in the secondary battery cell shown in FIG. 1;

FIG. 3 is a side view showing a configuration of a battery stack of a first embodiment;

FIG. 4 is a plan view showing a configuration of the battery stack of the first embodiment;

FIG. 5 is an exemplary diagram showing a configuration of a restraining member;

FIG. 6 is a side view showing a configuration of a battery stack of a second embodiment;

FIG. 7 is a plan view showing a configuration of the battery stack of the second embodiment;

FIG. 8 is a diagram showing the results of evaluation tests of battery stacks of Examples 1 and 2 and Comparative Examples 1 and 2; and

FIG. 9 is a diagram showing the results of evaluation tests of battery stacks of Example 3 and Comparative Example 3.

### DETAILED DESCRIPTION OF EMBODIMENTS

Hereinbelow, embodiments of the invention will be described with reference to the drawings. In the drawings, the same reference numerals are assigned to the same or corresponding portions, thereby omitting duplicate description thereof.

### First Embodiment

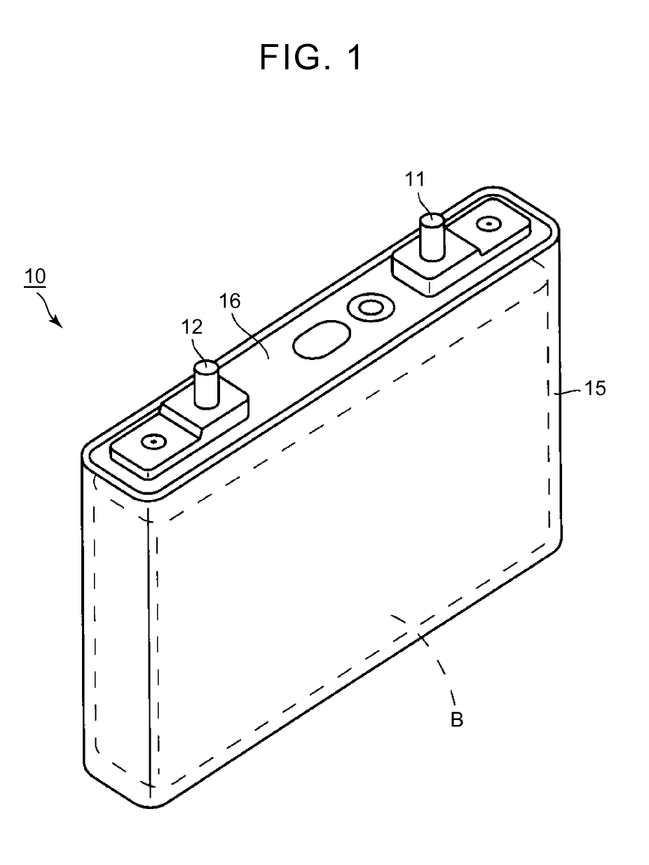

FIG. 1 is a perspective view showing a secondary battery cell 10 that forms a battery stack according to an embodiment of the invention. Referring to FIG. 1, a plurality of secondary battery cells 10 in this embodiment are combined in series to form a battery stack, which is installed in a hybrid vehicle. The battery stack serves as a power source of the hybrid vehicle along with an internal combustion engine such as a gasoline engine or a diesel engine.

The secondary battery cell 10 includes a battery element B, a case 15, a sealing member 16, a positive electrode terminal 11, and a negative electrode terminal 12. The battery element B is formed by stacking positive and negative electrode plates with a separator interposed therebetween. The case 15 has a generally rectangular parallelepiped shape that is open in one direction. The sealing member 16 has a flat plate shape that is generally rectangular in plan view. The sealing member 16 is provided so as to close the opening of the case 15. The case 15 and the sealing member 16 are made of a conductive material such as a metal typified by aluminum.

The case 15 and the sealing member 16 jointly define a sealed space. The case 15 and the sealing member 16 jointly form an outer package of the secondary battery cell 10. The case 15 and the sealing member 16 jointly form a housing that receives the battery element B therein. The housing of the secondary battery cell 10 has a generally rectangular parallelepiped shape. In the housing, the battery element B is placed along with an electrolyte solution. The electrolyte solution contains a gas generating agent (overcharge additive) that can be decomposed to generate a gas when a predetermined battery voltage is exceeded.

The positive electrode terminal 11 and the negative electrode terminal 12 are attached to the sealing member 16. The positive electrode terminal 11 and the negative electrode terminal 12 are provided so as to protrude from the housing of the secondary battery cell 10. The positive electrode terminal 11 and the negative electrode terminal 12 are disposed outside the housing of the secondary battery cell 10. The positive electrode terminal 11 and the negative electrode terminal 12 form external terminals of the secondary battery cell 10.

The secondary battery cell 10 includes a mechanism (current interrupt device 100) configured to interrupt the flow of current between the battery element B and the external terminal when the internal pressure of the case 15 is increased. The current interrupt device 100 is provided to at least one of the positive electrode terminal 11 and the negative electrode terminal 12.

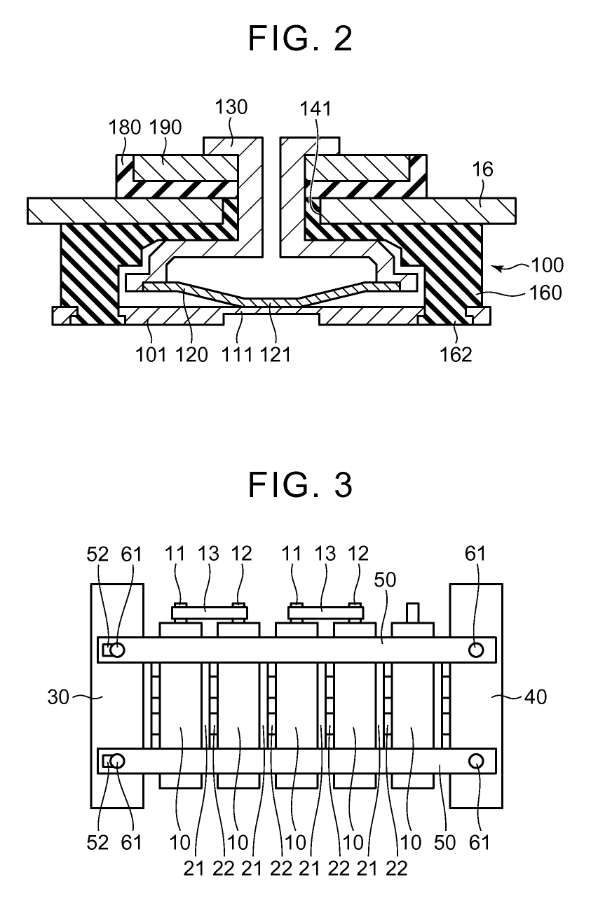

FIG. 2 is a diagram for explaining the current interrupt device 100 provided in the secondary battery cell 10. The current interrupt device 100 is mounted in the secondary battery cell 10 shown in FIG. 1.

The current interrupt device 100 is a pressure-type current interrupt device and is used in a sealed-type battery. Specifically, the current interrupt device 100 operates when the battery internal pressure (the pressure in the housing formed by the case 15 and the sealing member 16) is increased, thereby interrupting a current between the battery element B and the external terminal (the positive electrode terminal 11 or the negative electrode terminal 12).

As shown in FIG. 2, the current interrupt device 100 includes an insulator 180, a conductive member 130, an inversion plate 120, a current collector terminal (current collector plate) 101, and a holder member 160.

A terminal plate 190 shown in FIG. 2 is made of a conductive material and electrically connected to the external terminal (the positive electrode terminal 11 or the negative electrode terminal 12) shown in FIG. 1. The insulator 180 is made of an insulating material. The insulator 180 is interposed between the sealing member 16 and the terminal plate 190. The insulator 180 provides electrical insulation between the sealing member 16 and the terminal plate 190.

The conductive member 130 is made of a conductive material such as copper or aluminum. The sealing member 16 is formed with a through hole 141 penetrating the flat plate-shaped sealing member 16 in its thickness direction. The conductive member 130 passes through the through hole 141. The conductive member 130 is fitted into the through hole 141. The conductive member 130 is connected to the terminal plate 190 outside the housing of the secondary battery cell 10 and connected to the inversion plate 120 inside the housing of the secondary battery cell 10. The conductive member 130 establishes electrical connection between the terminal plate 190 and the inversion plate 120. The conductive member 130 has a shape whose diameter increases in the housing of the secondary battery cell 10, and the inversion plate 120 is attached to the increased-diameter portion of the conductive member 130.

The inversion plate 120 and the current collector terminal 101 are disposed in the housing of the secondary battery cell 10. The inversion plate 120 is made of a conductive material. The inversion plate 120 is disposed between the conductive member 130 and the current collector terminal 101. The inversion plate 120 is fixed to the conductive member 130 and the current collector terminal 101, for example, by welding. The inversion plate 120 establishes electrical connection between the conductive member 130 and the current collector terminal 101. Normally, the inversion plate 120 is concave on the conductive member 130 side and convex on the current collector terminal 101 side.

The inversion plate 120 has a generally disk shape. The inversion plate 120 has a pressure sensitive surface 121 at its central portion. The current collector terminal 101 has a thin portion 111 at its central portion. Normally, the pressure sensitive surface 121 is fixed to the thin portion 111. The edge portion of the inversion plate 120 is fixed to the conductive member 130.

The holder member 160 is provided in the housing of the secondary battery cell 10. The holder member 160 is provided directly under the sealing member 16. The holder member 160 is disposed so as to be sandwiched between the sealing member 16 and the conductive member 130. The outer peripheral portion of the conductive member 130 is in contact with the holder member 160. The holder member 160 holds the current collector terminal 101. The holder member 160 also serves to seal the through hole 141 formed in the sealing member 16.

The holder member 160 has a caulking portion 162. The current collector terminal 101 is caulked by the caulking portion 162 so as to be held by the holder member 160.

The current collector terminal 101 is connected to the electrode of the battery element B shown in FIG. 1. Before the current interrupt device 100 starts to operate, electric power (current) from the battery element B flows through the current collector terminal 101, the inversion plate 120, the conductive member 130, the terminal plate 190, and the external terminal (the positive electrode terminal 11 or the negative electrode terminal 12) in this order. Consequently, the electric power is supplied from the secondary battery cell 10 to the outside. When charging the secondary battery cell 10, a current flows in a direction opposite to the above.

When the internal pressure (of the housing formed by the case 15 and the sealing member 16) of the secondary battery cell 10 is increased, the pressure sensitive surface 121 is pressed by a gas in the housing. The rigidity of the thin portion 111 of the current collector terminal 101 is low compared to the other portions. Therefore, when the internal pressure of the housing is increased to a predetermined pressure (working pressure) or more, breakage occurs at the thin portion 111 of the current collector terminal 101 so that the inversion plate 120 is deformed in a direction away from the current collector terminal 101. More specifically, the inversion plate 120 is inverted so as to be convex on the conductive member 130 side and concave on the current collector terminal 101 side.

When the inversion plate 120 is deformed due to the breakage of the welded portion between the thin portion 111 of the current collector terminal 101 and the pressure sensitive surface 121 of the inversion plate 120, the conductive member 130 and the current collector terminal 101 are isolated from each other. By this theory, electrical connection between the battery element B and the external terminal is interrupted so that a current flowing between the battery element B and the external terminal is interrupted.

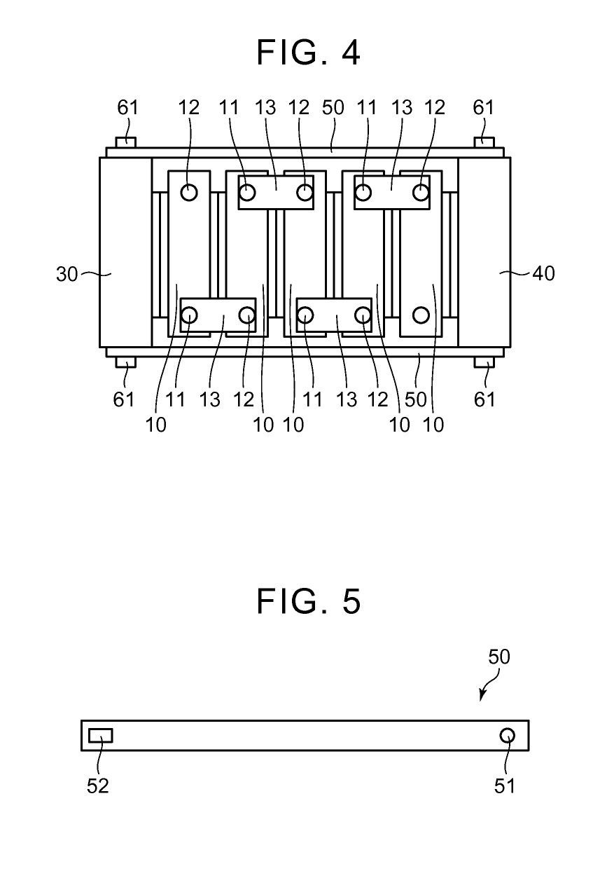

FIG. 3 is a side view showing a configuration of a battery stack of a first embodiment. FIG. 4 is a plan view showing a configuration of the battery stack of the first embodiment. The battery stack shown in FIGS. 3 and 4 is formed by connecting a plurality of secondary battery cells 10 of which one has been described with reference to FIGS. 1 and 2. In the battery stack, the secondary battery cells 10 are stacked in a left-right direction in the figures, thereby forming a stacked body. The secondary battery cells 10 are arranged so that side surfaces, having the largest area, of the respective housings face each other.

The secondary battery cells 10 are connected to each other by bus bars 13. The secondary battery cells 10 are stacked in a state where directions of the secondary battery cells 10 are alternately reversed so that the positive electrode terminal 11 and the negative electrode terminal 12 adjoin each other between the adjacent two secondary battery cells 10. The positive electrode terminal 11 of each secondary battery cell 10 is disposed adjacent to the negative electrode terminal 12 of the adjacent secondary battery cell 10, and the positive electrode terminal 11 and the negative electrode terminal 12 are connected to each other by the bus bar 13. Consequently, the secondary battery cells 10 are connected in series.

End plates 30 and 40 are disposed at both ends, in the stacking direction (left-right direction in FIGS. 3 and 4) of the secondary battery cells 10, of the stacked body. The end plate 30 is disposed at one end in the stacking direction with respect to the stacked body of the secondary battery cells 10. The end plate 40 is disposed at the other end in the stacking direction with respect to the stacked body of the secondary battery cells 10. The end plates 30 and 40 are disposed so that their main surfaces face each other. The secondary battery cells 10 are arranged between the end plates 30 and 40. The end plates 30 and 40 sandwich therebetween the stacked body of the secondary battery cells 10 from both sides in the stacking direction of the secondary battery cells 10.

Intervening members 21 and 22 are disposed between the adjacent secondary battery cells 10, 10. Since the intervening members 21 and 22 are interposed between the adjacent secondary battery cells 10, the secondary battery cells 10 are respectively arranged at a distance from each other. The intervening member 21 is made of an insulating material and ensures insulation between the adjacent two secondary battery cells 10. The intervening member 22 forms a gap between the intervening member 21 and the secondary battery cell 10, thereby facilitating cooling of the secondary battery cell 10.

The end plates 30 and 40 are coupled to each other by restraining members 50. Each restraining member 50 extends in the stacking direction of the secondary battery cells 10 of the stacked body from the end plate 30 to the end plate 40. As shown in FIG. 3, the restraining members 50 are provided in plural in a height direction (up-down direction in FIG. 3) of the secondary battery cells 10 and the end plates 30 and 40. As shown in FIG. 4, the restraining members 50 are provided on both side surfaces of the end plates 30 and 40.

The stacked body of the secondary battery cells 10 therearound is restrained by the end plates 30 and 40 and the restraining members 50. The stacked body of the secondary battery cells 10 is pressed in the stacking direction. The restraining members 50 apply, to the end plates 30 and 40, restraint loads that sandwich and restrain the stacked body of the secondary battery cells 10 from both sides in the stacking direction.

FIG. 5 is an exemplary diagram showing a configuration of the restraining member 50. As shown in FIG. 5, the restraining member 50 has an elongated plate shape. The restraining member 50 is formed with a circular hole 51 and an elongated hole 52. The circular hole 51 and the elongated hole 52 are each formed as a through hole penetrating the restraining member 50 in its thickness direction. The circular hole 51 is formed near one end of the restraining member 50. The elongated hole 52 is formed near the other end of the restraining member 50. The elongated hole 52 has a shape extending in an extending direction of the restraining member 50.

The restraining member 50 is fixed to the end plates 30 and 40 by fixing members 61 such as pins or screws. The fixing member 61 passes through the elongated hole 52 formed in the restraining member 50 and is fixed to the end plate 30. The fixing member 61 passes through the circular hole 51 formed in the restraining member 50 and is fixed to the end plate 40. The circular hole 51 is formed at a portion where the restraining member 50 is joined to the end plate 40. The elongated hole 52 is formed at a portion where the restraining member 50 is joined to the end plate 30.

In the state where the restraining member 50 is joined to the end plates 30 and 40 by the fixing members 61, the circular hole 51 is covered in its entirety by the fixing member 61 in side view of the battery stack shown in FIG. 3. On the other hand, the elongated hole 52 is covered only partially by the fixing member 61 and, as shown in FIG. 3, part of the elongated hole 52 is visible from the side.

The restraining member 50 extends in the stacking direction of the secondary battery cells 10 of the stacked body. The elongated hole 52 extends in the extending direction of the restraining member 50. Therefore, in the state where the restraining member 50 is joined to the end plates 30 and 40, the elongated hole 52 extends in the stacking direction of the secondary battery cells 10 of the stacked body.

The battery stack shown in FIGS. 3 and 4 can be manufactured as follows. First, the secondary battery cells 10 of which one is shown in FIG. 1 are prepared. The secondary battery cells 10 are stacked in one direction, then the end plates 30 and 40 are disposed at both ends of the stacked body, and then the intervening members 21 and 22 are disposed between the adjacent secondary battery cells 10. Using a known pressing jig or apparatus, a pressing force in the stacking direction of the secondary battery cells 10 of the stacked body is applied to the end plates 30 and 40.

In the state where the stacked body is pressed from both sides, the restraining members 50 are joined to the end plates 30 and 40. More specifically, in the state where the restraining members 50 are disposed on the side surfaces of the end plates 30 and 40, the fixing members 61 are inserted through the circular holes 51 of the restraining members 50 and fixed to the end plate 40 and, likewise, the fixing members 61 are inserted through the elongated holes 52 of the restraining members 50 and fixed to the end plate 30.

In this manner, restraint loads that sandwich the stacked body of the secondary battery cells 10 from both sides in the stacking direction are applied to the stacked body of the secondary battery cells 10, thereby obtaining the battery stack in which the secondary battery cells 10 are restrained.

In the battery stack thus configured, each secondary battery cell 10 includes the current interrupt device 100 in the housing as described above. Further, the gas generating agent (overcharge additive) is provided in the housing of the secondary battery cell 10. At the time of overcharging, the gas generating agent generates a gas to increase the internal pressure of the housing, thereby operating the current interrupt device 100 to interrupt a current. Consequently, the secondary battery cell 10 is protected against overcharging.

In order to reliably operate the current interrupt device 100 at the time of overcharging, a sufficient amount of gas generation is required. However, if degassing from the battery element B is insufficient, the electrolyte solution is forced out due to remaining gas so that reaction is inhibited, leading to a reduction in gas generation. As a result, the amount of gas generation becomes insufficient.

Therefore, in the battery stack of this embodiment, the elongated hole 52 is formed in each restraining member 50. The elongated hole 52 extends in the extending direction of the restraining member 50. In the state where the restraining members 50 are attached to the end plates 30 and 40, the elongated holes 52 each extend in the stacking direction of the secondary battery cells 10. The end plate 30 is provided so as to be able to change its relative position with respect to the restraining members 50 along the elongated holes 52. In the state where the restraining members 50 are joined to both the end plates 30 and 40, the end plate 30 is movable relative to the end plate 40 in the stacking direction of the secondary battery cells 10.

Consequently, the stacked body of the secondary battery cells 10 is configured such that its length in the stacking direction is variable in the state where it is restrained from both sides by the end plates 30 and 40. Accordingly, each secondary battery cell 10 is allowed to increase its dimension in its thickness direction. When a gas is generated in each secondary battery cell 10 to increase the internal pressure at the time of overcharging, since each secondary battery cell 10 can be expanded in its thickness direction, degassing from the battery element B is facilitated.

With the configuration described above, at the time of overcharging, a sufficient amount of gas is obtained in the housing of each secondary battery cell 10 so that it is possible to reliably operate the current interrupt device 100.

### Second Embodiment

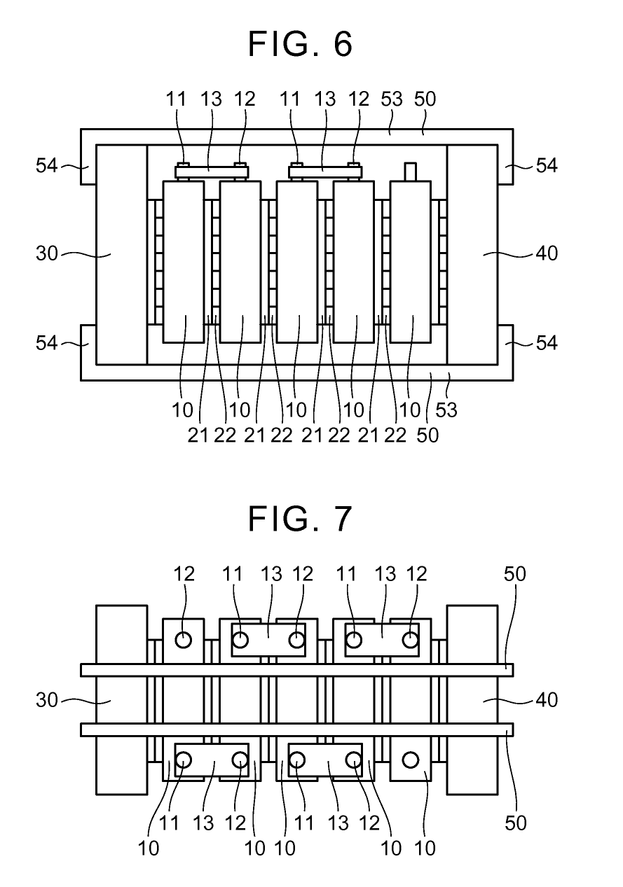

FIG. 6 is a side view showing a configuration of a battery stack of a second embodiment. FIG. 7 is a plan view showing a configuration of the battery stack of the second embodiment. The battery stack of the second embodiment shown in FIGS. 6 and 7 differs from the battery stack of the first embodiment in a configuration of a restraining member 50.

Specifically, restraining members 50 of the second embodiment each have an extending portion 53 extending in a stacking direction of secondary battery cells 10 and engaging portions 54 provided at both ends of the extending portion 53 and engaging with end plates 30 and 40. The engaging portions 54 are each in contact with a main surface, on the side not facing the secondary battery cell 10, of the end plate 30 or 40. The engaging portions 54 are respectively fixed to the end plates 30 and 40 using fixing members not shown in FIGS. 6 and 7.

The extending portion 53 and the engaging portions 54 are each formed by a flat plate-shaped member. The restraining member 50 may be formed by machining a single plate-shaped member or may be formed by joining together plate-shaped members that respectively form the extending portion 53 and the engaging portions 54.

The restraining members 50 of the second embodiment apply restraint loads to a structure, in which a stacked body of the secondary battery cells 10 is sandwiched from both sides by the end plates 30 and 40, by sandwiching the structure from both ends.

In the battery stack of the second embodiment thus configured, by properly selecting the material and shape of the extending portions 53 of the restraining members 50, the extending portions 53 are deformed when a force of the secondary battery cells 10 to expand in a thickness direction thereof is applied to the extending portions 53 at the time of overcharging. Consequently, in the state where the restraining members 50 are joined to both the end plates 30 and 40, the end plate 30 is movable relative to the end plate 40 in the stacking direction of the secondary battery cells 10.

Therefore, as in the first embodiment, since each secondary battery cell 10 can be expanded in its thickness direction at the time of overcharging, degassing from the battery element B is facilitated and thus a sufficient amount of gas is obtained in the housing of each secondary battery cell 10 so that it is possible to reliably operate the current interrupt device 100.

Hereinbelow, Examples of the invention will be described. In the following Examples, a test of increasing the internal pressure of the secondary battery cell 10 and an overcharge test of overcharging the secondary battery cell 10 were carried out for the battery stacks described in the above embodiments.

Secondary battery cells 10 of two specifications, i.e. cell specification A and cell specification B, were prepared. In the secondary battery cell 10 of cell specification A, a positive electrode was a ternary positive electrode, while a material of a negative electrode was graphite. As an overcharge additive, 2 wt % cyclohexylbenzene (CHB) was used. As a separator isolating positive and negative electrode plates of a battery element B from each other and holding an electrolyte solution between the electrode plates, a three-layer separator of PP (polypropylene)/PE (polyethylene)/PP was used. The external dimensions of the secondary battery cell 10 were set to 150 mm in a width direction, 26 mm in a thickness direction, and 90 mm in a height direction. The capacity of the secondary battery cell 10 was set to 30 Ah.

The thickness direction of the secondary battery cell 10 corresponds to a direction in which a plurality of secondary battery cells 10 are stacked (left-right direction in FIGS. 3 and 4). The height direction of the secondary battery cell 10 corresponds to an up-down direction in FIG. 3. The width direction of the secondary battery cell 10 corresponds to an up-down direction in FIG. 4. The width direction, the thickness direction, and the height direction of the secondary battery cell 10 are three directions perpendicular to each other.

In the secondary battery cell 10 of cell specification B, a positive electrode was a ternary positive electrode, while a material of a negative electrode was graphite. As an overcharge additive, 2 wt % cyclohexylbenzene (CHB) was used. As a separator provided between positive and negative electrode plates of a battery element B and holding an electrolyte solution, a three-layer separator of PP (polypropylene)/PE (polyethylene)/PP was used. The external dimensions of the secondary battery cell 10 were set to 138 mm in a width direction, 13 mm in a thickness direction, and 63 mm in a height direction. The capacity of the secondary battery cell 10 was set to 4 Ah.

The prepared secondary battery cells 10 were stacked to form a stacked body and end plates 30 and 40 were respectively disposed at both ends in a stacking direction of the stacked body. In the state where a load of 500 kgf was applied in the stacking direction of the stacked body, fixing members 61 (bolts) were fastened to the end plates 30 and 40 at 3 N·m, thereby restraining a battery stack.

A test of increasing the internal pressure of the secondary battery cell 10 was carried out by forming a hole in one of the secondary battery cells 10 included in the battery stack and applying a pressure of 0.3 MPa to this secondary battery cell 10 from the outside. A change in the dimension (stack entire length) of the battery stack in the stacking direction of the stacked body in this event was measured.

An overcharge test was carried out for the secondary battery cell 10 attached with an internal pressure sensor under test conditions of charging condition 20A (charging to SOC (State of Charge) 145%) and test temperature 25° C. An internal pressure increase of the secondary battery cell 10 at the time of overcharging was measured and a comparison was made.

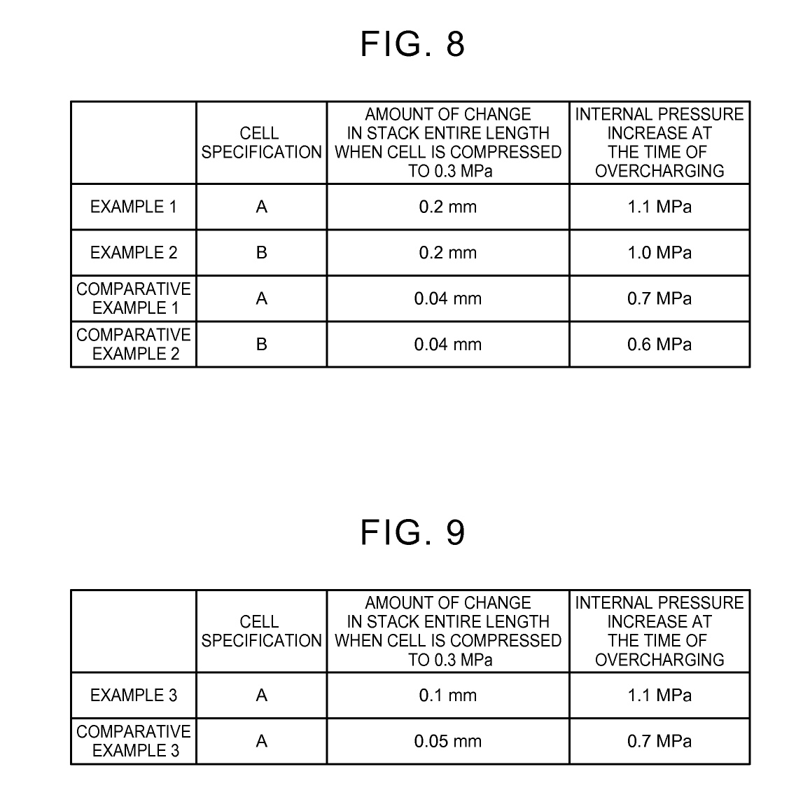

FIG. 8 is a diagram showing the results of evaluation tests of battery stacks of Examples 1 and 2 and Comparative Examples 1 and 2. In Examples 1 and 2, the tests were carried out using battery stacks according to the first embodiment. In Comparative Examples 1 and 2, the tests were carried out using battery stacks including restraining members each formed with, instead of the elongated hole 52 of the restraining member 50 of the first embodiment, a circular hole like the circular hole 51 of the restraining member 50 of the first embodiment.

As shown in FIG. 8, in the case of Examples 1 and 2, the stack entire length was increased by 0.2 mm when the secondary battery cell 10 was compressed to 0.3 MPa. On the other hand, in the case of Comparative Examples 1 and 2, the stack entire length was increased only by 0.04 mm when the secondary battery cell 10 was compressed to 0.3 MPa.

Further, as shown in FIG. 8, in the case of Examples 1 and 2, since the stack entire length was allowed to change at the time of an internal pressure increase of the secondary battery cell 10, internal pressure increases of 1.1 MPa and 1.0 MPa were respectively achieved at the time of overcharging. On the other hand, in the case of Comparative Examples 1 and 2, the internal pressures were respectively increased only by 0.7 MPa and 0.6 MPa at the time of overcharging.

FIG. 9 is a diagram showing the results of evaluation tests of battery stacks of Example 3 and Comparative Example 3. In Example 3 and Comparative Example 3, the tests were carried out using battery stacks according to the second embodiment. In Example 3, the cross-sectional area of each of restraining members 50 was set to 4 mm². In Comparative Example 3, the cross-sectional area of each of restraining members 50 was set to 8 mm². The restraining members 50 of Example 3 were configured to be smaller in rigidity and thus to be deformed more easily than the restraining members 50 of Comparative Example 3.

As shown in FIG. 9, in the case of Example 3, the stack entire length was increased by 0.1 mm when the secondary battery cell 10 was compressed to 0.3 MPa. On the other hand, in the case of Comparative Example 3, the stack entire length was increased only by 0.05 mm when the secondary battery cell 10 was compressed to 0.3 MPa.

Further, as shown in FIG. 9, in the case of Example 3, since the stack entire length was allowed to change at the time of an internal pressure increase of the secondary battery cell 10, an internal pressure increase of 1.1 MPa was achieved at the time of overcharging. On the other hand, in the case of Comparative Example 3, the internal pressure was increased only by 0.7 MPa at the time of overcharging.

Therefore, if the end plate 30 is configured to be movable relative to the end plate 40 by forming the elongated holes 52 in the restraining members 50 or forming the restraining members 50 to be easily deformable, the stack entire length of the battery stack can be increased at the time of overcharging, thereby allowing expansion of each secondary battery cell 10 in its thickness direction. As a result, it is possible to ensure a sufficient amount of gas generation at the time of overcharging and thus to reliably operate the current interrupt device 100.

While the embodiments and Examples of the invention have been described above, it is to be understood that the embodiments disclosed this time are for illustrative purposes only and are not intended to limit the invention in any aspect. It is intended that the scope of the invention be defined by the scope of the claims, not by the above description and that equivalents of the scope of the claims and all changes within the scope of the claims be included in the scope of the invention.

What is claimed is:

1. A battery stack comprising:
a plurality of battery cells each including:
a battery element;
a housing in which the battery element is housed;
an external terminal disposed outside the housing; and
a current interrupt device configured to operate when an internal pressure of the housing is increased, thereby interrupting electrical connection between the battery element and the external terminal,
the plurality of battery cells stacked in one direction to form a stacked body,
the battery stack further comprising:
a first end plate disposed at one end, in the one direction, of the stacked body;
a second end plate disposed at the other end, in the one direction, of the stacked body; and
a restraining member joined to the first end plate and the second end plate and configured to apply, to the first end plate and the second end plate, restraint loads that sandwich and restrain the stacked body from both sides in the one direction,
wherein the first end plate is movable relative to the second end plate in a state where the restraining member is joined to both the first end plate and the second end plate.

2. The battery stack according to claim 1, wherein an elongated hole extending in the one direction is formed at a portion, joined to the first end plate, of the restraining member.

3. The battery stack according to claim 2, wherein a fixing member passes through the elongated hole and is fixed to the first end plate.

4. The battery stack according to claim 1, wherein the restraining member includes
an extending portion extending in the one direction and configured to be deformable; and
engaging portions provided at both ends of the extending portion and engaging with the first end plate and the second end plate.
